(19) United States
(12) Patent Application Publication
(10) Pub. No.: US 2013/0124688 A1
(43) Pub. Date: May 16, 2013

(54) WIRELESS NETWORK SYSTEM AND CONTENT PROVISION METHOD USING THE SAME

(71) Applicants: Jee-Wan HUH, Jeju Do (KR); Sangsu JUNG, Kyongsangnam Do (KR)

(72) Inventors: Jee-Wan HUH, Jeju Do (KR); Sangsu JUNG, Kyongsangnam Do (KR)

(73) Assignee: KOREA BASIC SCIENCE INSTITUTE, Daejeon (KR)

(21) Appl. No.: 13/329,849

(22) Filed: Dec. 19, 2011

(30) Foreign Application Priority Data
Nov. 16, 2011 (KR) 10-2011-0119324

(51) Int. Cl. G06F 15/16

(52) U.S. Cl. 709/219

(57) ABSTRACT

Disclosed herein is a wireless network system. The wireless network system includes a plurality of user terminals, a plurality of access points, a plurality of content source servers, and a plurality of content storage units. The plurality of access points is wirelessly connected to the plurality of user terminals. The plurality of content source servers provides content to the access points. The plurality of content storage units each stores the content, received from the content source servers, for each of the access points.

### BACKGROUND OF THE INVENTION

1. Field of the Invention

The present invention relates generally to a wireless network system and a content provision method using the same and, more particularly, to a method which selects, using a negotiation protocol unit which selects a plurality of available access points, a plurality of access points from among service access points which can be connected to a specific user terminal over a wireless mobile network, including a plurality of access points and a plurality of user terminals, by taking into consideration the network status between the access points, and then causes the selected access points to request content from content source servers, to receive and store the content, and to transmit the corresponding content to the user terminal in a distributed manner, in order to increase the utilization efficiency of network resources and to provide a rapid content transmission service and a service with seamless connection during movement.

2. Description of the Related Art

A wireless network system includes access points for providing services, such as an Internet service, and user terminals for receiving the services. Generally, such an access point is connected to a wired network in order to provide an Internet service, and a single access point can provide services to a plurality of user terminals.

With the recent and rapid increase in the number of mobile communication terminals, such as smart phones and tablet Personal Computers (PC), access points are closely arranged to accommodate the mobile communication terminals. This has resulted in the problems of interference between access points, which causes a decrease in network capacity, and the no use of spectra, which disables network resources from being sufficiently used.

Multihoming is a technique which is used to maintain access to homogeneous or heterogeneous links in a multiple manner by assigning multiple Internet Protocol (IP) addresses to a user terminal. Since the various interfaces of a user terminal are used, there are advantages in that available network resources can be effectively utilized, and in that a service can be continued if a link which maintains access exists even when a partial disconnection problem occurs. Meanwhile, in order to cover content-based networking which has become of concern lately, it is necessary to consider the settings between multiple interfaces, the utilization of service links, and the utilization of memory relevant to access points.

Meanwhile, content-based networking refers to networking which processes data transmission by assigning a virtual code to content itself and mapping the virtual code to an address rather than by using the existing IP address system. Since multimedia and various types of large amounts of content exist on a network, the content-based networking enables the multimedia and the various types of large amounts content to be efficiently managed and appropriately transmitted to destinations. Current technology has focused on the distribution of content simply using a data center or a caching server without cooperation between content storage units and access points.

### SUMMARY OF THE INVENTION

Accordingly, the present invention has been made keeping in mind the above problems occurring in the prior art, and an object of the present invention is to provide a wireless network system and a content provision method using the same which can efficiently transmit content to a user using a plurality of access points which exist on a wireless network in a cooperative manner rather than an individual manner. For this purpose, service access points are selected based on the status of a network, and content is cached in the selected access points. Another object of the present invention is to provide a wireless network system and a content provision method using the same in which each of the access points appropriately transmits independent or duplicated data to the user, thereby providing a rapid content transmission service and a service with seamless connection during movement.

In order to accomplish the above object, the present invention provides a wireless network system, including a plurality of user terminals; a plurality of access points wirelessly connected to the plurality of user terminals; a plurality of content source servers configured to provide content to the access points; and a plurality of content storage units each configured to store the content, received from the content source servers, for each of the access points.

Further, the wireless network system may include a negotiation protocol unit for, when each of the user terminals requests content, determining whether each of the plurality of access points should join in a transmission access point group for providing the content to the corresponding user terminal.

Here, the user terminal may receive the content from the access points which joined in the transmission access point group based on the determination of the negotiation protocol unit.

Further, the negotiation protocol unit may determine whether each of the plurality of access points should join in the transmission access point group depending on whether the access point includes a relevant content storage unit.

Further, the negotiation protocol unit may determine whether each of the plurality of access points should join in the transmission access point group based on the strength of a signal received by the access point from the user terminal.

Further, the negotiation protocol unit may determine whether each of the plurality of access points should join in the transmission access point group based on the number of the user terminals which are connected to provide the content.

Further, the negotiation protocol unit may determine whether each of the plurality of access point should join in the transmission access point group based on the degree of data traffic which is being provided.

In order to accomplish the above object, the present invention provides a method of providing content to a specific user terminal using a wireless network system including a plurality of user terminals, a plurality of access points wirelessly connected to the plurality of user terminals, a plurality of content source servers configured to provide content to the access points, and a plurality of content storage units each configured to store the content, received from the content source servers, for each of the access points, the method including receiving a request for content from a specific one of the user terminals; and selecting one or more access points using a negotiation protocol unit for determining whether each of the plurality of access points should join in a transmission access point group for transmitting the content to the user terminal which requested the content.

Further, the content provision method may further includes establishing a connection between the selected access points, and the specific user terminal; and receiving the content from the access points, to which the connection was established, using the specific user terminal.

Here, the negotiation protocol unit may determine whether each of the plurality of access points should join in a transmission access point group based on any one or more of the following conditions: whether each of the content storage units corresponding to the relevant access point preserves the content, whether the empty storage space of the content storage unit corresponding to the relevant access point is greater than a predefined value, whether a distance between the relevant access point and a relevant content source server is shorter than a predefined value, whether the relevant access point can be connected to another access point which preserves the content, whether the strength of a signal received by the access point from the user terminal is greater than a predefined value, whether the number of the user terminals connected to each of the plurality of access points in order to provide the content is lower than a predefined value, and whether the amount of data traffic, which is being provided by each of the plurality of access points, is lower than a predefined value.

Further, when the number of the access points which joined in the transmission access point group is lower than a preset value, the selecting one or more access points may performed again, so that the negotiation protocol unit selects access points again.

Further, the preservation time period of the content which is preserved in each of the content storage units is set to a longer period in proportion to the frequency of use of the corresponding content.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a view illustrating the configuration of a wireless network system according to an embodiment of the present invention;

FIG. 2 is a flowchart illustrating a process of grouping the access points of the wireless network system based on content according to an embodiment of the present invention;

FIG. 3 is a flowchart illustrating a process of caching content using the wireless network system according to an embodiment of the present invention;

FIG. 4 is a view illustrating an example of the content database of an access point and preservation time periods based on the frequencies of use of pieces of content according to an embodiment of the present invention;

FIG. 5 is a view illustrating an example of traffic transmission rates depending on the degrees of access point loads in an individual transmission mode according to an embodiment of the present invention; and

FIG. 6 is a view illustrating a process of grouping access points and performing cooperative transmission using the wireless network system according to an embodiment of the present invention.

### DESCRIPTION OF THE PREFERRED EMBODIMENTS

The embodiment of the present invention will be described in detail with reference to the accompanying drawings below. Herein, terms or words used in the present specification and claims should not be limitedly interpreted as common or dictionary meanings, and should be interpreted as meanings and concepts which accord with the technical spirit of the invention based on a principle in that an inventor may appropriately define the concepts of terms and words in order to describe his/her invention using the best way.

Therefore, since embodiments described in the present specification and configuration illustrated in the drawings are the most preferred embodiments of the present invention and do not represent all the technical spirit of the present invention, it should be understood that there are various equivalents and modifications which may substitute for the preferred embodiments at the time point of application of the present invention.

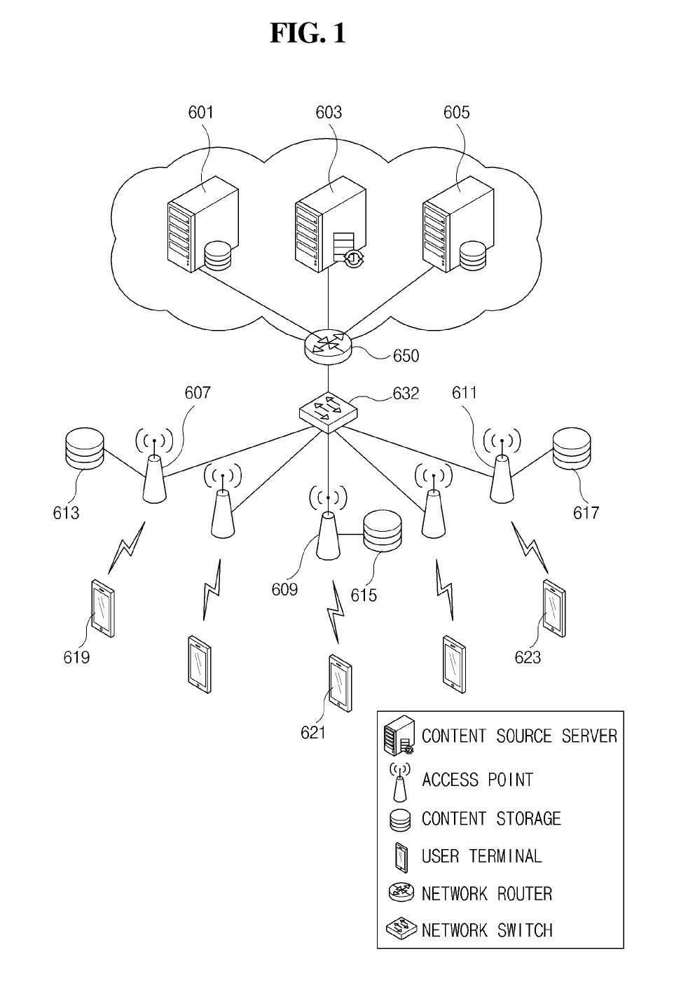

FIG. 1 is a view illustrating the configuration of a wireless network system according to the present invention. This drawing shows transmission over a single network using a plurality of content source servers including content source servers 601, 603, and 605 each of which distributes content, a network router 650 for separating networks, and a network switch 632 for branching the network. The wireless network system includes a plurality of access points including access points 607, 609, and 611 each of which wirelessly provides a content transmission service to a user, a plurality of content storage units including content storage units 613, 615, and 617 which store content transmitted to the relevant access points from the content source servers and which are connected to the access points, and a plurality of user terminals including user terminals 619, 621, and 623 each of which receives a service via the plurality of access points.

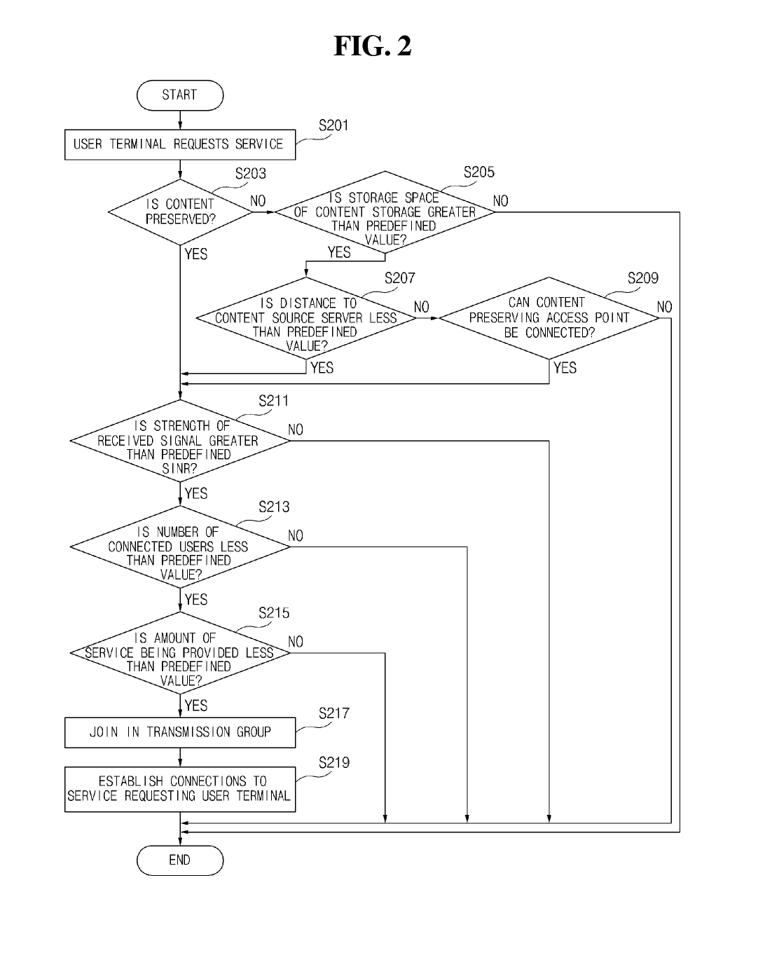

FIG. 2 is a flowchart illustrating a process of grouping the access points of the wireless network system based on content according to the present invention.

An arbitrary user terminal (here, the arbitrary user terminal refers to a node which requests that content should be received at a predefined specific time point) searches for connectable access points in order to receive content. The arbitrary user terminal requests the transmission of a service from the found access points at step S201. Thereafter, if the access points include requested content (“Yes” at step S203), each of the access points determines whether to join in a transmission group for providing a service to a user at step S217 based on the strength of a signal received from the user terminal at step S211, the number of user terminals connected to provide the service at step S213, and the degree of data traffic which is being provided at step S215. If the access points do not include the requested content (“No” at step S203), each of the access points determines whether to join in the transmission group at step S217 by taking into consideration the capacity of a content storage unit connected to the access point at step S205, and the distance between the access point and a content source server which preserves the content at step S207 or a probability that an access point which preserves the content can be connected at step S209, other than the strength of a signal received from the user terminal at step S211, the number of user terminals connected to provide the service at step S213, and the degree of data traffic which is being provided at step S215. After access points which will be included in the transmission group are selected, the access points which are included in the transmission group establish connections with the arbitrary user terminal at step S219.

Meanwhile, when the number of access points included in the transmission group is less than a preset value because of the movement of the user terminal, the user terminal requests a process of regrouping transmission access points using a group retransmission message.

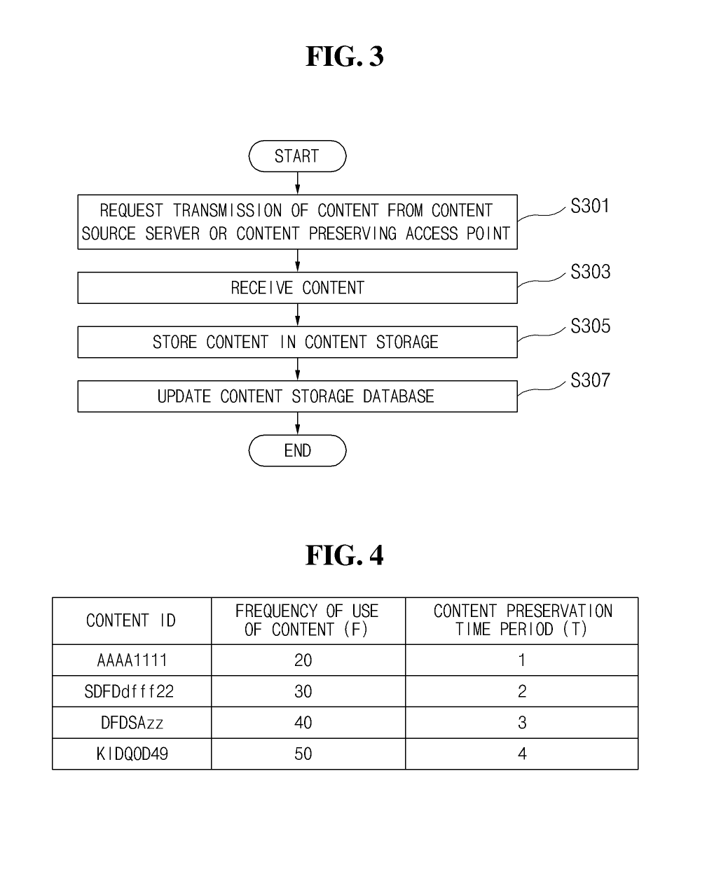

FIG. 3 is a flowchart illustrating a process of caching content using the wireless network system according to the present invention. When the access points selected for the transmission group do not have the content requested by the arbitrary user terminal, the access points request the transmission of the content, requested by the arbitrary user terminal, from the content source servers or access points having the content at step S301. The content source servers or the access points, having the content, transmit the content to the access points of the transmission group which requested the transmission of the content at step S303. Each of the access points, which has received the content and are included in the transmission group, stores the content in a content storage unit which is connected to the access point at step S305. The access point updates a database related to the content at step S307. Here, the database may record the frequency of use of the content, store the content during a preservation time period set based on the frequency of use of the content, and then remove the content.

FIG. 4 is a view illustrating an example of the content database of an access point and preservation time periods set based on the frequencies of use of pieces of content.

A preservation time period T may be set to a higher value when the frequency of use of the content is higher, so that unnecessary transmission between a content source server and an access point and a time required to transmit a service to the user terminal can be minimized.

Meanwhile, the access points included in the transmission group may select one of individual transmission mode and duplicated transmission mode in order to cooperatively transmit content to an arbitrary user terminal.

In individual transmission mode, an access point with a lower load transmits a larger amount of traffic to the arbitrary user terminal.

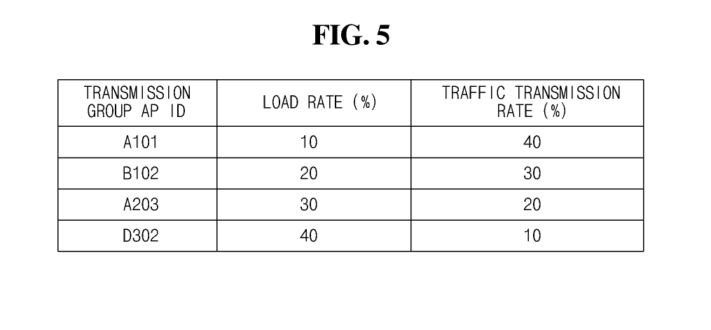

FIG. 5 illustrates an example of traffic transmission rates depending on the degrees of access point loads in the individual transmission mode.

Such an access point transmits content traffic to the arbitrary user terminal based on a corresponding traffic transmission rate, and the arbitrary user terminal rearranges packets when the order of received content traffic packets is not correct.

In such a cooperative transmission process performed by the access points, it is preferable that each of the access points collects information about the movement of the user terminal, a disconnected access point notifies the other access points of the transmission group of disconnection status when a disconnection occurs, so that the access points of the transmission group may change the mode to duplicated transmission mode.

In duplicated transmission mode, rateall access points included in the transmission group may transmit the same content traffic. Therefore, there are advantages of ensuring high reliability when a service is provided using a user terminal, and ultimately maximizing the range of traffic transmission.

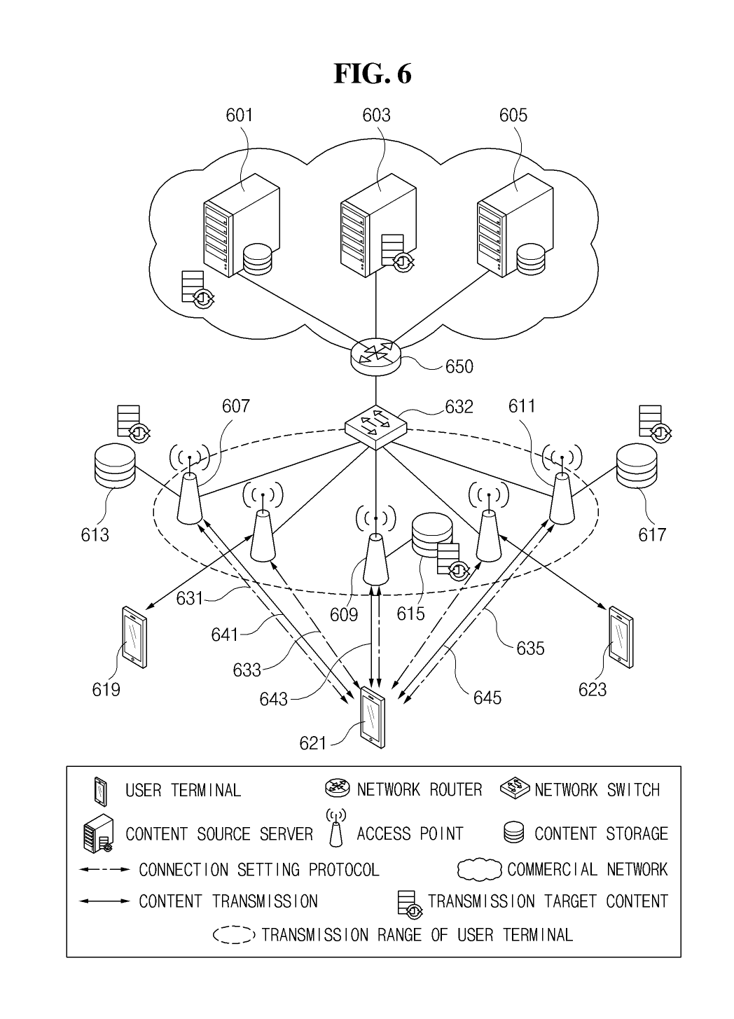

FIG. 6 is a view illustrating a process of grouping access points and performing cooperative transmission using the wireless network system according to an embodiment of the present invention.

In detail, content source servers 601, 603, and 605 for providing content to a commercial network, such as the Internet, are divided into for internal and external networks by a network router 650, and provide content to the internal network by a network switch 633.

In the case of a wireless network, content is provided to a user terminal by access points 607, 609, and 611, which are connected to the network switch 633, after authentication.

The connected access points according to the embodiment of the present invention include respective content storage units 613, 615, and 617.

Each of the user terminals 619, 621, and 623 connects to a plurality of access points which are within the propagation range and which do not exceed the total transmission bandwidth of the user terminal.

For example, a user terminal 621 transmits connection request signals 631, 633, and 635 to access points. One or more connectable access points 607, 609, and 611 which belong to access points which have received the connection request signals and which are connectable indicative of connectability based on the current network load rates transmit signals 641, 643, and 645 indicative of connectability to the user terminal.

The user terminal, which received the signals indicative of connectability from the respective access points, assigns an additional address to a network apparatus, thereby forming a multi-transmission environment with the access points.

The access points, connected to the user terminal, mutually exchange information about content which is being transmitted, and store the information in the respective content storage units 613, 615, and 617 of the access points.

Here, a method of storing, grouping access points, and transmitting content have been already described with reference to FIGS. 3 to 5.

When the wireless network system and the content provision method using the same according to the embodiments of the present invention are used, a user establishes connections with a plurality of access points selected from among available access points in order to receive a service over a wireless network, and the system and method can sufficiently utilize available network resources compared to the existing case where a service is received via a single access point, so that the user may receive a larger amount of data and so that the user can receive a service without undergoing disconnection and a hand-over procedure during movement if at least one access point in charge of the service is connected to.

Further, the transmission and management of content of each access point can be performed in real time at the request of a user. That is, there are advantages in that the limited storage space of each access point can be efficiently utilized, and in that a user can further rapidly access content because the content is transmitted to an access point which is close to the user through a content source server.

Further, the transmission of the same data of multiple access points in a duplicate manner is supported. Such duplicate data transmission, performed over a wireless network in which the status of a channel is unstable unlike in a wired network, has the advantage of improving reliability.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A wireless network system, comprising:
a plurality of user terminals;
a plurality of access points wirelessly connected to the plurality of user terminals;
a plurality of content source servers configured to provide content to the access points; and
a plurality of content storage units each configured to store the content, received from the content source servers, for each of the access points.

2. The wireless network system as set forth in claim 1, further comprising a negotiation protocol unit for, when each of the user terminals requests content, determining whether each of the plurality of access points should join in a transmission access point group for providing the content to the corresponding user terminal.

3. The wireless network system as set forth in claim 2, wherein the user terminal receives the content from the access points which joined in the transmission access point group based on the determination of the negotiation protocol unit.

4. The wireless network system as set forth in claim 3, wherein the negotiation protocol unit determines whether each of the plurality of access points should join in the transmission access point group depending on whether the access point includes a relevant content storage unit.

5. The wireless network system as set forth in claim 3, wherein the negotiation protocol unit determines whether each of the plurality of access points should join in the transmission access point group based on strength of a signal received by the access point from the user terminal.

6. The wireless network system as set forth in claim 3, wherein the negotiation protocol unit determines whether each of the plurality of access points should join in the transmission access point group based on a number of the user terminals which are connected to provide the content.

7. The wireless network system as set forth in claim 3, wherein the negotiation protocol unit determines whether each of the plurality of access point should join in the transmission access point group based on a degree of data traffic which is being provided.

8. A method of providing content to a specific user terminal using a wireless network system including a plurality of user terminals, a plurality of access points wirelessly connected to the plurality of user terminals, a plurality of content source servers configured to provide content to the access points, and a plurality of content storage units each configured to store the content, received from the content source servers, for each of the access points, the method comprising:
receiving a request for content from a specific one of the user terminals; and
selecting one or more access points using a negotiation protocol unit for determining whether each of the plurality of access points should join in a transmission access point group for transmitting the content to the user terminal which requested the content.

9. The content provision method as set forth in claim 8, further comprising:
establishing a connection between the selected access points, and the specific user terminal; and
receiving the content from the access points, to which the connection was established, using the specific user terminal.

10. The content provision method as set forth in claim 9, wherein the negotiation protocol unit determines whether each of the plurality of access points should join in a transmission access point group based on any one or more of the following conditions:
whether each of the content storage units corresponding to the relevant access point preserves the content,
whether an empty storage space of the content storage unit corresponding to the relevant access point is greater than a predefined value,
whether a distance between the relevant access point and a relevant content source server is shorter than a predefined value,
whether the relevant access point can be connected to another access point which preserves the content,
whether strength of a signal received by the access point from the user terminal is greater than a predefined value,
whether a number of the user terminals connected to each of the plurality of access points in order to provide the content is lower than a predefined value, and
whether an amount of data traffic, which is being provided by each of the plurality of access points, is lower than a predefined value.

11. The content provision method as set forth in claim 8, wherein, when a number of the access points which joined in the transmission access point group is lower than a preset value, performing the selecting one or more access points again, so that the negotiation protocol unit selects the access points again.

12. The content provision method as set forth in claim 8, wherein a preservation time period of the content which is preserved in each of the content storage units is set to a longer period in proportion to a frequency of use of the corresponding content.
